(19) United States
(12) Patent Application Publication
(10) Pub. No.: US 2017/0238326 A1
(43) Pub. Date: Aug. 17, 2017

(54) METHOD FOR COMMUNICATING IN UNLICENSED BAND AND DEVICE USING SAME

(71) Applicant: LG ELECTRONICS INC., Seoul (KR)

(72) Inventors: Joonkui AHN, Seoul (KR); Hanbyul SEO, Seoul (KR); Seungmin LEE, Seoul (KR); Hyangsun YOU, Seoul (KR); Yunjung YI, Seoul (KR); Daesung HWANG, Seoul (KR)

(73) Assignee: LG ELECTRONICS INC., Seoul (KR)

(21) Appl. No.: 15/502,471

(22) PCT Filed: Aug. 4, 2015
(86) PCT No.: PCT/KR2015/008151

§ 371 Date: Feb. 7, 2017

Related U.S. Application Data
(60) Provisional application No. 62/034,189, filed on Aug. 7, 2014.
(60) Provisional application No. 62/046,187, filed on Sep. 5, 2014.
(60) Provisional application No. 62/075,899, filed on Nov. 6, 2014.

(51) Int. Cl. H04W 72/08; H04W 72/04; H04W 24/10

(52) U.S. Cl. CPC H04W 72/082; H04W 24/10; H04W 72/0446; H04W 72/0406; H04W 84/12

(57) ABSTRACT

Provided are a method for communicating in a wireless communication system and a device using the same. A wireless device establishes connection with a primary cell operating in a licensed band, and, by the instruction of the primary cell, activates a secondary cell operating in an unlicensed band. Defined in the secondary cell is a suspension duration which is configured on the basis of the downlink (DL) timing of the primary cell, thereby having DL transmission in the secondary cell suspended therein.

### BACKGROUND OF THE INVENTION

Field of the invention

The present invention relates to wireless communication, and more particularly, to a method for communicating in an unlicensed band in a wireless communication system, and a device using the method.

Related Art

With the explosive increase in mobile data traffic in recent years, a service provider has utilized a wireless local area network (WLAN) to distribute the data traffic. Since the WLAN uses an unlicensed band, the service provider can address a demand for a significant amount of data without the cost of an additional frequency. However, there is a problem in that an interference phenomenon becomes serious due to a competitive WLAN installation between the providers, quality of service (QoS) cannot be guaranteed when there are many users, and mobility cannot be supported. As one of methods for compensating this, a long term evolution (LTE) service in the unlicensed band is emerged.

LTE in unlicensed spectrum (LTE-U) or licensed-assisted access using LTE (LAA) is a technique in which an LTE licensed band is used as an anchor to combine a licensed band and an unlicensed band by the use of carrier aggregation (CA). A user equipment (UE) first accesses a network in the licensed band. A base station (BS) may offload traffic of the licensed band to the unlicensed band by combining the licensed band and the unlicensed band according to a situation.

The LTE-U may extend an advantage of LTE to the unlicensed band to provide improved mobility, security, and communication quality, and may increase a throughput since the LTE has higher frequency efficiency than the legacy radio access technique.

Unlike the licensed band in which exclusive utilization is guaranteed, the unlicensed band is shared with various radio access techniques such as the WLAN. Therefore, each communication node acquires a channel to be used in the unlicensed band in a contention-based manner, and this is called a carrier sense multiple access with collision avoidance (CSMA/CA). Each communication node must perform channel sensing before transmitting a signal to confirm whether a channel is idle, and this is called clear channel assessment (CCA).

Since various wireless access techniques perform the CCA in the unlicensed band, there is a need for a method capable of reducing an interference.

### SUMMARY OF THE INVENTION

The present invention provides a method communicating in an unlicensed band and a device using the same.

In an aspect, a method for communicating in a wireless communication system includes establishing, by a wireless device, a connection with a primary cell operating in a licensed band, and activating, by the wireless device, a secondary cell operating in an unlicensed band by an instruction of the primary cell. A suspension duration which is configured based on a downlink (DL) timing of the primary cell to suspend a DL transmission of the secondary cell is defined in the secondary cell.

The secondary cell may measure an interference strength caused by a neighboring communication node during the suspension duration.

In another aspect, a device in a wireless communication system includes a radio frequency (RF) unit configured to transmit and receive a radio signal, and a processor operatively coupled to the RF unit. The processor is configured to instruct the RF unit to establish a connection with a primary cell operating in a licensed band, and instruct the RF unit to activate a secondary cell operating in an unlicensed band by an instruction of the primary cell. A suspension duration which is configured based on a downlink (DL) timing of the primary cell to suspend a DL transmission of the secondary cell is defined in the secondary cell.

An interference can be reduced in an environment where various communication protocols coexist in an unlicensed band.

### BRIEF DESCRIPTION OF THE DRAWINGS

FIG. 1 shows an example of a long term evolution (LTE) service using an unlicensed band.

FIG. 2 shows a deployment of a planned wireless communication system.

FIG. 3 shows a deployment of an unplanned wireless communication system.

FIG. 4 shows a communication method according to an embodiment of the present invention.

FIG. 5 shows an example of configuring an inter-system/operator measurement gap (ISMG).

FIG. 6 shows another example of configuring an ISMG.

FIG. 7 shows another example of configuring an ISMG.

FIG. 8 is a block diagram showing a wireless communication system for implementing an embodiment of the present invention.

### DESCRIPTION OF EXEMPLARY EMBODIMENTS

A wireless device may be fixed or mobile, and may be referred to as another terminology, such as a user equipment (UE), a mobile station (MS), a mobile terminal (MT), a user terminal (UT), a subscriber station (SS), a personal digital assistant (PDA), a wireless modem, a handheld device, etc. Alternatively, the wireless device may be a device supporting a data communication such as a machine-type communication (MTC) device.

A base station (BS) is generally a fixed station that communicates with the wireless device, and may be referred to as another terminology, such as an evolved-NodeB (eNB), a base transceiver system (BTS), an access point, etc.

It is described hereinafter that the present invention is applied based on 3rd generation partnership project (3GPP) long term evolution (LTE) based on 3GPP Technical Specification (TS). This is for exemplary purposes only, and the present invention is also applicable to various wireless communication systems.

A wireless device may be served by a plurality of serving cells under carrier aggregation (CA) or a dual connectivity. Each serving cell may be defined by one downlink (DL) component carrier (CC) or a pair of a DL CC and an uplink (UL) CC.

A serving cell may be classified into a primary cell and a secondary cell. The primary cell is a cell which operates at a primary frequency, performs an initial connection establishment procedure, starts a connection reestablishment procedure, or is designated as a primary cell in a handover procedure. The primary cell refers to a reference cell. The secondary cell may operate at a secondary frequency, may be configured after a Radio Resource Control (RRC) connection is established, and may be used to provide additional radio resources. Substantially, at least one primary cell may be configured, and the secondary cell may be added/modified/released according to higher layer signaling (e.g., radio resource control (RRC)).

A cell index (CI) of the primary cell may be fixed. For example, the lowest CI may be designated as the CI of the primary cell. Hereinafter, a CI of the primary cell is 0, and a CI of the secondary cell is sequentially allocated from 1.

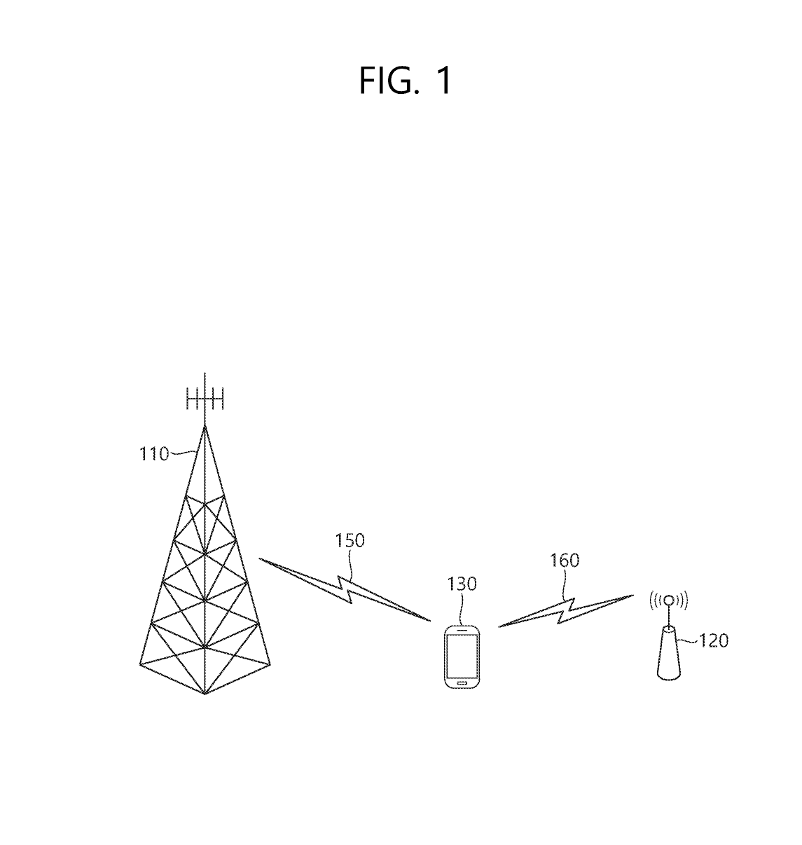

FIG. 1 shows an example of an LTE service using an unlicensed band.

A wireless device 130 establishes a connection with a 1st BS 110, and receives a service through a licensed band. For traffic offloading, the wireless device 130 may receive a service through an unlicensed band with respect to a 2nd BS 120.

The 1st BS 110 is a BS supporting an LTE system, whereas the 2nd BS 120 may also support other communication protocols such as a wireless local area network (WLAN) in addition to LTE. The 1st BS 110 and the 2nd BS 120 may be associated with a carrier aggregation (CA) environment, and a specific cell of the 1st BS 110 may be a primary cell. Alternatively, the 1st BS 110 and the 2nd BS 120 may be associated with a dual connectivity environment, and a specific cell of the 1st BS 110 may be a primary cell. In general, the 1st BS 110 having the primary cell has wider coverage than the 2nd BS 120. The 1st BS 110 may be called a macro cell. The 2nd BS 120 may be called a small cell, a femto cell, or a micro cell. The 1st BS 110 may operate the primary cell and zero or more secondary cells. The 2nd BS 120 may operate one or more secondary cells. The secondary cell may be activated/deactivated by an indication of the primary cell.

The above description is for exemplary purposes only. The 1st BS 110 may correspond to the primary cell, and the 2nd BS 120 may correspond to the secondary cell, so that the cell can be managed by one BS.

The licensed band is a band in which an exclusive use is guaranteed to a specific communication protocol or a specific provider.

The unlicensed band is a band in which various communication protocols coexist and a shared use is guaranteed. The unlicensed band may include 2.5 GHz and/or 5 GHz band used in a WLAN.

It is assumed in the unlicensed band that a channel is occupied basically through contention between respective communication nodes. Therefore, in communication in the unlicensed band, it is required to confirm that signal transmission is not achieved by other communication nodes by performing channel sensing. This is called a listen before talk (LBT). A clear channel assessment (CCA) is confirmed when it is determined that no other communication nodes does not send any signals.

The LBT must be performed preferentially in order for a BS or wireless device of an LTE system to have access to a channel in an unlicensed band. Further, when the BS or wireless device of the LTE system transmits a signal, an interference problem may occur since other communication nodes such as the WLAN or the like also perform the LBT. For example, in the WLAN, a CCA threshold is defined as −62 dBm as to a non-WLAN signal and is defined as −82 dBm as to a WLAN signal. This means that interference may occur in an LTE signal due to other WLAN devices when the LTE signal is received with power less than or equal to −62 dBm.

Hereinafter, ‘performing LBT’ or ‘performing CCA’ means that a communication node access a channel after the communication node confirms that the channel is idle or that other communication node does not use the channel.

Hereinafter, the LTE and the WLAN are described for example as a communication protocol used in the unlicensed band. This is for exemplary purposes only, and thus it may also be said that a 1st communication protocol and a 2nd communication protocol are used in the unlicensed band. A base station (BS) supports the LTE. A UE is a device supporting the LTE.

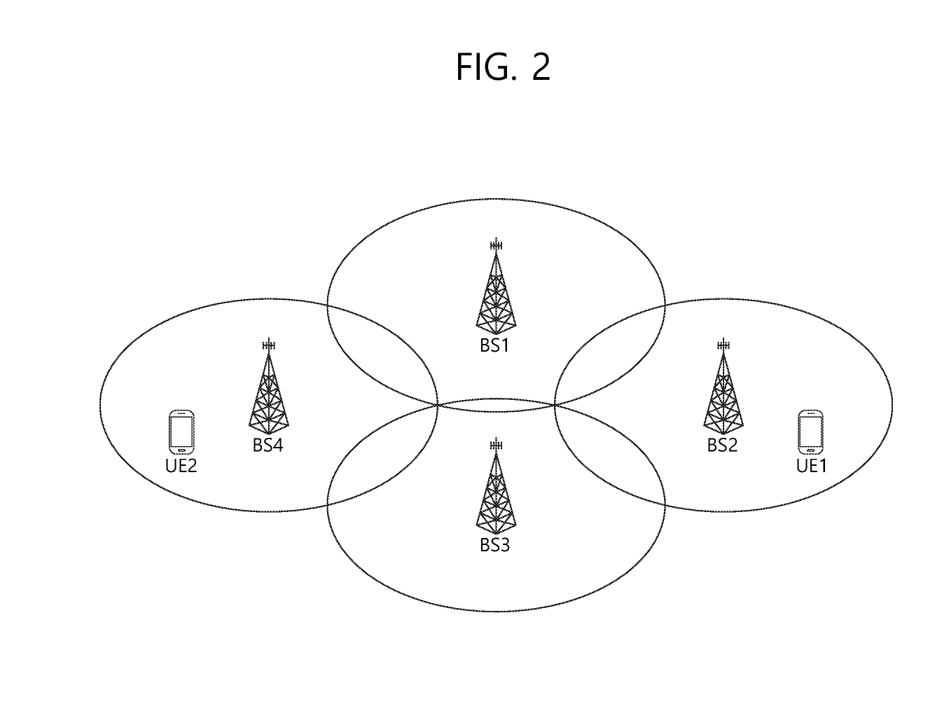

FIG. 2 shows a deployment of a planned wireless communication system.

Each of a BS1, a BS2, a BS3, and a BS4 has a proper cell coverage, and operates in a planned environment even in an unlicensed band, thereby not requiring an operation such as a listen before talk (LBT).

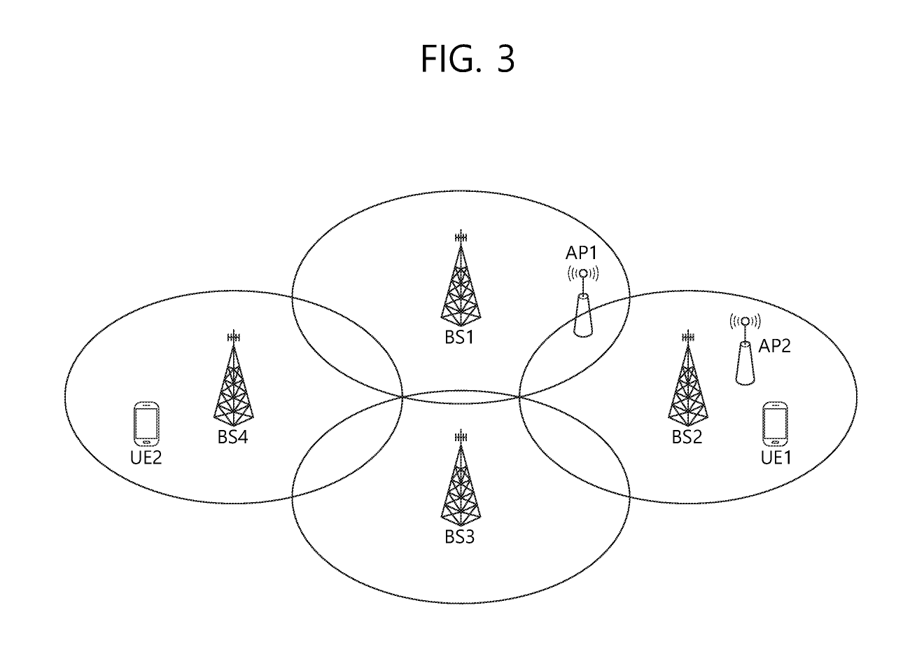

FIG. 3 shows a deployment of an unplanned wireless communication system.

It is shown that an access point (AP) supporting WLAN is deployed in a cell. An AP1 and an AP2 are deployed without proper cell planning, and an LBT operation is required to reduce an interference in an unlicensed band. A BS1 and a BS2 which are adjacent at least to the AP1 and the AP2 need to perform the LBT.

To mitigate the interference in the unlicensed band, an inter-system or inter-operator measurement method of a BS is proposed.

It is assumed hereinafter that the BS performs scheduling on a subframe basis. For example, one subframe has a length of 1 ms, and this is called a transmission time interval (TTI). The subframe may include a plurality of orthogonal frequency division multiplexing (OFDM) symbols. Since the 3GPP LTE uses orthogonal frequency division multiple access (OFDMA) in a downlink (DL), the OFDM symbol is only for expressing one symbol period in a time domain, and there is no limitation in a multiple access scheme or terminologies. For example, the OFDM symbol may also be referred to as another terminology such as a single carrier-frequency division multiple access (SC-FDMA) symbol, a symbol period, etc.

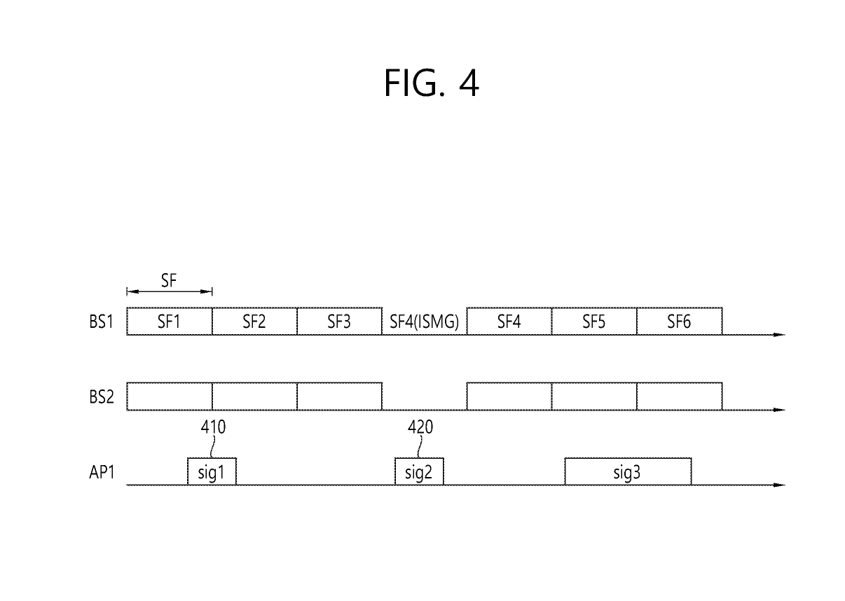

FIG. 4 shows a communication method according to an embodiment of the present invention.

A BS operating in an unlicensed band may suspend all DL transmissions in a designated duration. A duration in which the BS commonly suspends DL transmission for an inter-system/operator interference measurement is called an inter-system/operator measurement gap (ISMG) or a suspension duration.

A BS1 and a BS2 may suspend transmission of all DL signals including a cell specific reference signal (CRS) during the ISMG. The BS1 and the BS2 may attempt to detect a signal caused by another communication node in an unlicensed band during the ISMG. Since a first signal 410 transmitted by an API overlaps with transmission of the BS1/BS2, it is difficult for the BS1/BS2 to know whether the API exists. However, a second signal 420 transmitted by the API during the ISMG may be detected by the BS1/BS2. Therefore, the BS1/BS2 may recognize that the API exists nearby.

Although it is exemplified that a 4^{th} subframe SF4 is defined as the ISMG, a size/location/count of the ISMG is not limited thereto. Although it is exemplified that the ISMG includes one subframe, the ISMG may include at least one OFDM symbol or a plurality of subframes.

An ISMG timing (period and/or offset) and size may be predetermined or may be configured by a network. This configuration may be delivered between the BS s through a backhaul.

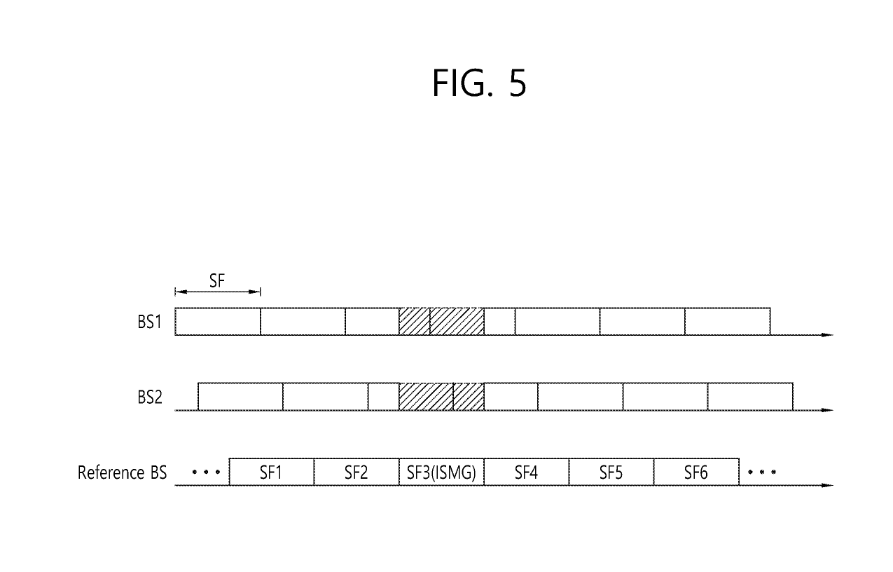

FIG. 5 shows an example of configuring an ISMG.

An ISMG timing of a BS1/BS2 operating in an unlicensed band may be defined on the basis of a timing of a reference BS operating in a licensed band. A 3^{rd} subframe SF3 of the reference BS is defined as the ISMG, and DL transmission of the BS1 and the BS2 is suspended in a duration corresponding thereto.

In the unlicensed band, a DL transmission timing such as a subframe boundary or the like may not be matched between neighboring cells. This is because an accurate time synchronization is not supported between BS s operating in the unlicensed band, or each BS may start to transmit a DL signal at any timing due to the LBT operation. Therefore, it is proposed to define the ISMG timing on the basis of a reference BS or a reference cell.

From a perspective of a UE, an ISMG timing of a cell to which the UE has access is configured on the basis of a timing of a reference cell to which the UE has access. The reference cell may be a primary cell or may be a cell of a licensed band operated by a BS collocated with the BS operating in the unlicensed band. If the reference cell is the primary cell, the BS1 and the BS2 in the figure may correspond to a secondary cell.

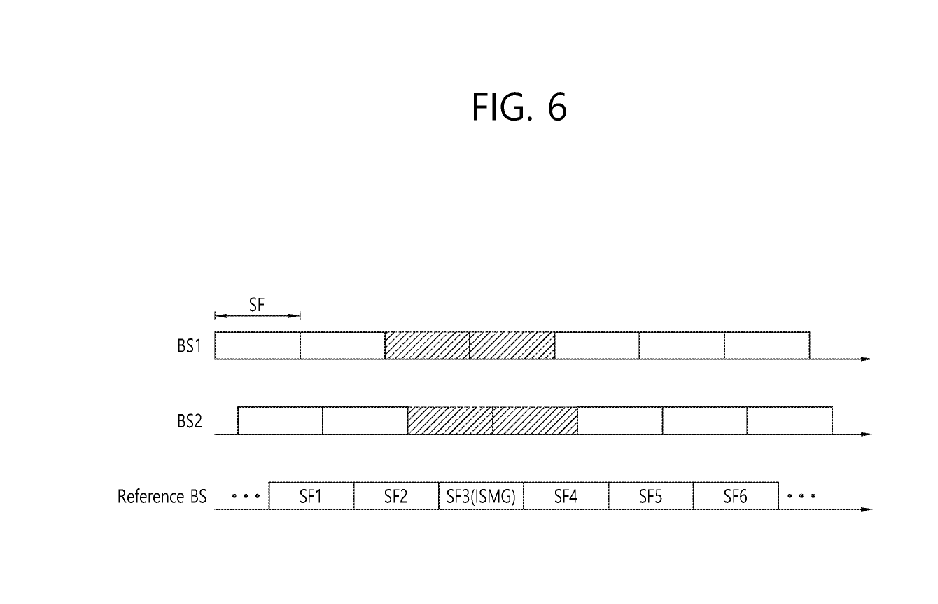

FIG. 6 shows another example of configuring an ISMG.

The embodiment of FIG. 5 shows that an BS1/BS2 suspends DL transmission only in a duration identical to an ISMG of a reference BS. On the contrary, an embodiment of FIG. 6 shows that DL transmission is suspended in all subframes overlapping with the ISMG of the reference BS.

If a cell of an unlicensed band operates in TDD, the ISMG may be defined in a UL subframe duration of the cell. Since the cell does not have to particularly suspend DL transmission, deterioration of DL transmission efficiency can be avoided.

If the cell of the unlicensed band operates in TDD, the ISMG may be defined in a gap duration in which DL/UL transmission/reception is not defined in a special (S) subframe of the cell. Since the cell does not have to particularly suspend DL transmission, deterioration of DL transmission efficiency can be avoided.

During the ISMG, not only DL transmission but also UL transmission can be suspended. This may be effective when both of the BS and the UE measure an interference level of a DL/UL channel or operate in an LBT manner. The BS which performs LBT may not perform DL transmission even if it is determined that a radio channel is not occupied in the ISMG duration, and the UE of a TDD system may not perform UL transmission even if it is determined that the radio channel is not occupied. Even in case of an FDD system, when the BS cannot simultaneously perform DL transmission and UL reception in the ISMG duration, the UE may not perform UL transmission even if it is determined that the radio channel is not occupied.

A duration used for transmission of control information such as a physical downlink control channel (PDCCH) or the like in a DL subframe may be excluded from the ISMG duration. A duration used for transmission of a sounding reference signal (SRS) in a UL subframe may be excluded from the ISMG duration.

If there are a plurality of cells operating in the unlicensed band, the ISMG may be commonly applied to all cells or may be commonly applied to a cell group.

The BS may accurately determine which communication mode is present around its coverage by integrating not only a received signal of another communication node but also a signal received from a neighboring BS to which the ISMG is not configured. Measurement information in the ISMG duration may be delivered between the BSs, and this may be performed in unit of a specific BS group.

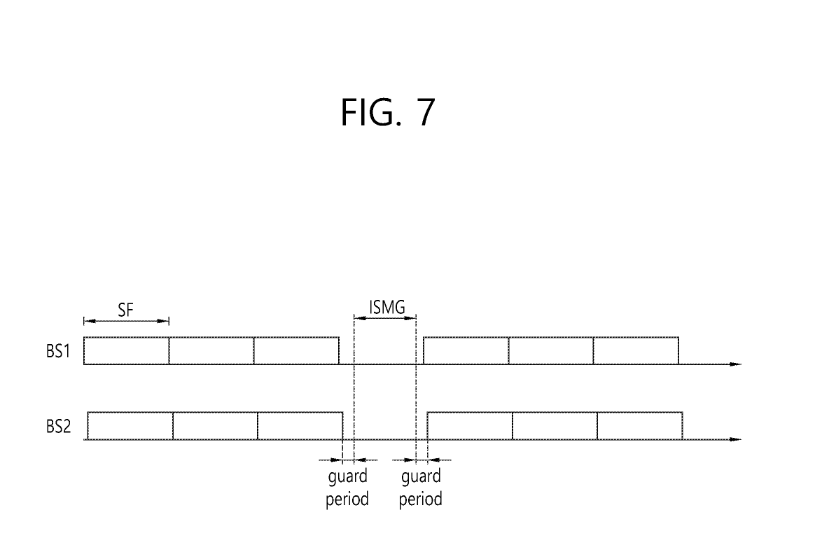

FIG. 7 shows another example of configuring an ISMG.

A guard period is defined at both sides or one side of the ISMG. A BS1/BS2 may measure signal strength of another communication node in an ISMG duration except for the guard period.

When the BS1/BS2 performs a measurement during the ISMG duration, if a subframe timing of a corresponding BS is not accurately matched to a subframe timing of a neighboring BS, a signal transmitted by the neighboring BS may act as an interference around a boundary of the ISMG duration and a non-ISMG duration. To reduce an interference from the neighboring BS, a guard period in which the measurement is not performed may be defined. The guard period may be used when the BS1/BS2 switches a transmission/reception operation.

An independent ISMG duration may be configured according to a type of an interference source to be measured by the BS. A first ISMG duration for measuring an interference/signal generated in a system other than an LTE system and a second ISMG duration for measuring an interference/signal generated in an LTE operator or system other than a specific LTE operator may be configured separately. Such a division may be effective when it is intended to distinguish an existence of an inter-LTE-operator interference and an existence of an inter-system interference in a case where DL transmission can be coordinated between LTE BSs belonging to different operators through an interference coordination/cancellation but such a coordination cannot be applied to an interference caused by a WLAN system. For a detailed example, it is assumed that an LTE system of an operation A, an LTE system of an operation B, an LTE system of an operation C, and a WLAN system co-exist. In order to exclude an interference from a BS/UE belonging to the operator A, an identical ISMG duration may be defined for BS s belonging to the operation A. In order to measure the interference from the WLAN system, an identical ISMG duration may be defined for all BS s belonging to the operator A/B/C.

In order to avoid an interference caused by transmission of the UE or to decrease an erroneous operation of the UE in the ISMG duration, information regarding the ISMG duration may be provided to the UE. In the ISMG duration, the UE may operate as follows.

(1) The UE does not expect DL transmission in an ISMG duration configured in a DL subframe.

(2) The UE does not perform UL transmission in an ISMG duration configured in a UL subframe.

(3) The UE does not expect scheduling for UL transmission in the ISMG duration. In 3GPP LTE, if the UE receives a UL grant through a PDCCH in a subframe n, UL data is transmitted in a subframe n+4. If the subframe n+4 is defined as an ISMG, the UE may discard transmission of UL data in the subframe n+4, or may not expect scheduling through the PDCCH in the subframe n.

(4) The UE does not transmit hybrid automatic repeat request (HARQ) ACK/NACK in the ISMG duration. In 3GPP LTE, if the UE receives DL data in the subframe n, HARQ ACK/NACK regarding the DL data is transmitted in the subframe n+4. If the subframe n+4 is defined as the ISMG, the UE may not expect to receive DL data in the subframe n. If the subframe n+4 is defined as the ISMG, the UE may discard transmission of HARQ ACK/NACK in the subframe n+4, or may deliver NACK to a higher layer.

(5) The UE may not perform a measurement for measuring quality of a neighboring cell in the ISMG duration.

If an interference greater than or equal to a specific level is detected in the ISMG duration while the BS does not perform the LBT operation, the BS or a BS group to which the BS belongs may start the LBT operation. Alternatively, if the interference is not detected in the ISMG duration while the LBT operation is performed, the BS or the BS group to which the BS belongs may suspend the LBT operation.

The unlicensed band may include a plurality of frequency carriers. The BS may switch a frequency carrier on the basis of a measurement result in the ISMG duration. If the BS detects an interference greater than or equal to a specific level in the ISMG duration of a first frequency carrier, the BS or the BS group to which the BS belongs may switch to a second frequency carrier on which a lower interference is detected.

An ISMG specified for each cell or each BS may be configured. Different ISMGs may be configured to BSs in a BS group belonging to the same operator. In order for the BS to determine whether to perform the LBT operation without having to distinguish an interference from a BS belonging to the same operator and an interference from a BS belonging to a different operator, the ISMG duration may not be necessarily adjusted to be identical between BSs belonging to the same operator. In this case, the ISMG may be applied only to a UE belonging to each BS. ISMG durations of different BSs may be adjusted not to overlap with each other through backhaul signaling. A timing of the ISMG may be determined on the basis of a cell identifier.

By measuring an interference level in the unlicensed band, the BS or the cell may determine whether to perform traffic offloading or whether to perform CCA. Alternatively, the BS/cell may improve a throughput by adjusting a CCA level. For example, if the interference level is low, the CCA may not be performed. If the interference level is excessively high, a collision caused by a channel access may be reduced by decreasing a CCA threshold or by increasing a backoff time.

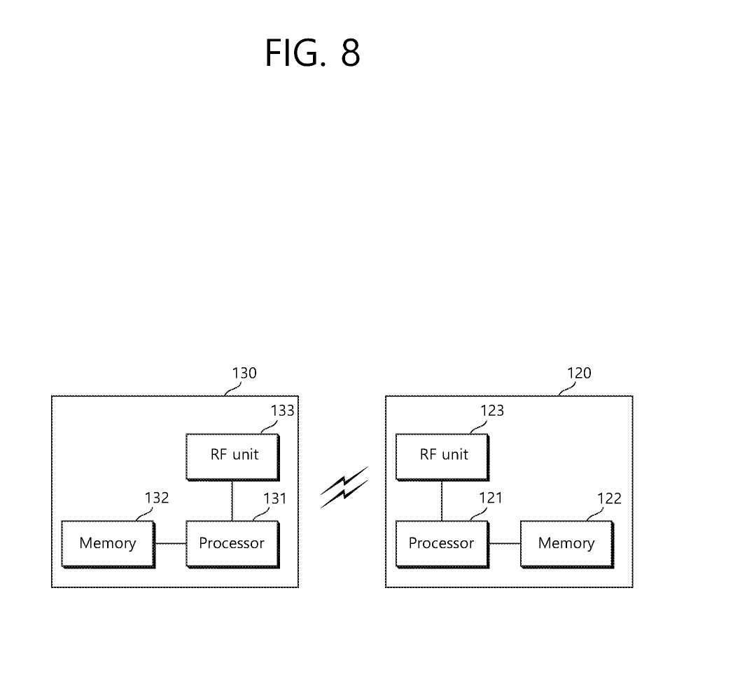

FIG. 8 is a block diagram showing a wireless communication system for implementing an embodiment of the present invention.

A wireless device 130 includes a processor 131, a memory 132, and a radio frequency (RF) unit 133. The memory 132 is coupled to the processor 131, and stores various instructions executed by the processor 131. The RF unit 133 is coupled to the processor 131, and transmits and/or receives a radio signal. The processor 131 implements the proposed functions, procedures, and/or methods. In the aforementioned embodiment, an operation of the wireless device may be implemented by the processor 131. When the aforementioned embodiment is implemented with a software instruction, the instruction may be stored in the memory 132, and may be executed by the processor 131 to perform the aforementioned operation.

A BS 120 includes a processor 121, a memory 122, and an RF unit 123. The BS 120 may operate in an unlicensed band. The memory 122 is coupled to the processor 121, and stores various instructions executed by the processor 121. The RF unit 123 is coupled to the processor 121, and transmits and/or receives a radio signal. The processor 121 implements the proposed functions, procedures, and/or methods. In the aforementioned embodiment, an operation of the BS may be implemented by the processor 121.

The processor may include Application-Specific Integrated Circuits (ASICs), other chipsets, logic circuits, and/or data processors. The memory may include Read-Only Memory (ROM), Random Access Memory (RAM), flash memory, memory cards, storage media and/or other storage devices. The RF unit may include a baseband circuit for processing a radio signal. When the above-described embodiment is implemented in software, the above-described scheme may be implemented using a module (process or function) which performs the above function. The module may be stored in the memory and executed by the processor. The memory may be disposed to the processor internally or externally and connected to the processor using a variety of well-known means.

In the above exemplary systems, although the methods have been described on the basis of the flowcharts using a series of the steps or blocks, the present invention is not limited to the sequence of the steps, and some of the steps may be performed at different sequences from the remaining steps or may be performed simultaneously with the remaining steps. Furthermore, those skilled in the art will understand that the steps shown in the flowcharts are not exclusive and may include other steps or one or more steps of the flowcharts may be deleted without affecting the scope of the present invention.

What is claimed is:

1. A method for communicating in a wireless communication system, the method comprising:
establishing, by a wireless device, a connection with a primary cell operating in a licensed band; and
activating, by the wireless device, a secondary cell operating in an unlicensed band by an instruction of the primary cell,
wherein a suspension duration which is configured based on a downlink (DL) timing of the primary cell to suspend a DL transmission of the secondary cell is defined in the secondary cell.

2. The method of claim 1, wherein the secondary cell measures an interference strength caused by a neighboring communication node during the suspension duration.

3. The method of claim 2, wherein the neighboring communication node is a communication node based on a wireless local area network (WLAN).

4. The method of claim 1,
wherein the DL timing of the primary cell is determined by a plurality of subframes, and
wherein the suspension duration overlaps with at least any one subframe of the plurality of subframes.

5. The method of claim 1, wherein guard periods are determined at both sides of the suspension duration.

6. The method of claim 1, wherein the wireless device suspends uplink (UL) transmission during the suspension duration.

7. The method of claim 1, wherein the wireless device accesses a channel by performing a clear channel assessment (CCA) in the unlicensed band.

8. A device in a wireless communication system, the device comprising:
a radio frequency (RF) unit configured to transmit and receive a radio signal; and
a processor operatively coupled to the RF unit and configured to:
instruct the RF unit to establish a connection with a primary cell operating in a licensed band; and
instruct the RF unit to activate a secondary cell operating in an unlicensed band by an instruction of the primary cell,
wherein a suspension duration which is configured based on a downlink (DL) timing of the primary cell to suspend a DL transmission of the secondary cell is defined in the secondary cell.

9. The device of claim 8, wherein the secondary cell measures an interference strength caused by a neighboring communication node during the suspension duration.

10. The device of claim 9, wherein the neighboring communication node is a communication node based on a wireless local area network (WLAN).

11. The device of claim 8,
wherein the DL timing of the primary cell is determined by a plurality of subframes, and
wherein the suspension duration overlaps with at least any one subframe of the plurality of subframes.

12. A method for communicating in a wireless communication system, the method comprising:
configuring, by a first base station, a suspension duration of a secondary cell operating in an unlicensed band based on a downlink (DL) timing of a primary cell operating in a licensed band; and
suspending, by the first base station, DL transmission of the secondary cell during the suspension duration, and measuring an interference strength caused by a neighboring communication node.

13. The method of claim 12, wherein a second base station commonly suspends DL transmission of the secondary cell operating in the unlicensed band during the suspension duration.

14. The method of claim 12, wherein the neighboring communication node is a communication node based on a wireless local area network (WLAN).
